(19) United States
(12) Patent Application Publication
(10) Pub. No.: US 2014/0202178 A1
(43) Pub. Date: Jul. 24, 2014

(54) MULTIPLE CIRCUIT COOLING SYSTEM

(71) Applicant: Michael W. Trumbower, Fort Wayne, IN (US)

(72) Inventor: Michael W. Trumbower, Fort Wayne, IN (US)

(21) Appl. No.: 14/130,111

(22) PCT Filed: Jul. 2, 2012
(86) PCT No.: PCT/US2012/045236

§ 371 Date: Dec. 30, 2013

Related U.S. Application Data
(60) Provisional application No. 61/502,907, filed on Jun. 30, 2011.

(51) Int. Cl. H01M 10/613

(52) U.S. Cl. CPC H01M 10/5004
USPC 62/62; 62/498; 62/509; 62/190; 62/426

(57) ABSTRACT

The present application provides a cooling system having a refrigerant-to-refrigerant heat exchanger having first and second flow passages extending therethrough and a cold plate having first and second flow passages extending therethrough, the first flow passage of the cold plate configured to communicate with the first flow passage of the heat exchanger and the second flow passage of the cold plate configured to communicate with the second flow passage of the heat exchanger. During low ambient air temperatures, a vehicle battery is cooled to its operational temperatures by the cold plate without having to operate a vapor compression loop.

### RELATED APPLICATIONS

This application claims the benefit of U.S. Provisional Application No. 61/502,907 filed Jun. 30, 2011, which is hereby incorporated herein by reference.

### FIELD OF INVENTION

The present invention relates generally to a cooling system, and more particularly to a multiple circuit cooling system for a vehicle.

### BACKGROUND

Hybrid vehicles include an internal combustion engine, one or more electric motors, and one or more batteries, such as lithium-ion batteries, for energy storage. By storing energy in the batteries, the hybrid vehicles provide increased fuel economy, increased brake life, and reduction in the size and weight of an internal combustion engine. Hybrid vehicles use power electronics to convert the energy in the one or more batteries to energy for driving the one or more electric motor. The power electronics generate heat during operation, and a cooling system, such as a liquid cooling system, may be used to cool the power electronics during vehicle operation. The lithium-ion batteries also generate heat, for example during charging and discharging. To prevent damage to the battery or vehicle due to overheating, a cooling system may also be used to cool the battery.

The internal combustion engine also generates heat during operation. A radiator may be used to cool the internal combustion engine, for example by passing a liquid through an engine block, where the liquid is heated, and then through the radiator where the heat is expelled.

### SUMMARY OF INVENTION

The present invention provides a cooling system having a refrigerant-to-refrigerant heat exchanger having first and second flow passages extending therethrough and a cold plate having first and second flow passages extending therethrough, the first flow passage of the cold plate configured to communicate with the first flow passage of the heat exchanger and the second flow passage of the cold plate configured to communicate with the second flow passage of the heat exchanger. During low ambient air temperatures, a vehicle battery is cooled to its operational temperatures by the cold plate without having to operate a vapor compression loop.

According to one aspect of the invention, a vehicle is providing including a battery, a pumped loop cooling circuit including a pump and a condenser, a vapor compression circuit including an expansion valve and a compressor, a refrigerant-to-refrigerant heat exchanger having first and second flow passages in heat exchange relationship, the first flow passage forming part of the pumped loop cooling circuit and the second flow passage forming part of the vapor compression circuit and serving as a condenser in the vapor compression circuit, an evaporator in heat exchange relationship with the battery to cool the battery, the evaporator having a first flow passage forming part of the pumped loop cooling circuit and a second flow passage forming part of the vapor compression circuit, and a diverter valve for controlling the flow of a two-phase refrigerant through the pumped loop cooling circuit, the diverter valve having a first operational state for directing the refrigerant to the evaporator to cool the battery and a second operational state bypassing the evaporator.

In an embodiment, the vehicle further includes power electronics and the pumped loop cooling circuit further including a second evaporator in heat exchange relationship with the power electronics to cool the power electronics.

In another embodiment, the second evaporator is downstream of the diverter valve and upstream of the condenser.

In still another embodiment, when the diverter valve is in the first operational state, the two-phase refrigerant flows from the pump, through the refrigerant-to-refrigerant heat exchanger to the evaporator to cool the battery, from the evaporator to the second evaporator to cool the power electronics, and from the second evaporator to the condenser where the two-phase refrigerant is condensed and cooled via a fan blowing air across the condenser.

In yet another embodiment, the pumped loop cooling circuit further includes a reservoir configured to receive the refrigerant from the condenser and deliver the refrigerant to the pump.

In a further embodiment, when the diverter valve is in the second operational state, the vapor compression circuit is activated to cool the battery with a two-phase refrigerant flowing through the vapor compression circuit.

In another embodiment, wherein when a temperature of the vehicle is at or below a first temperature, the diverter valve is in the first operational state and when a temperature of the vehicle is a second temperature greater than the first temperature, the diverter valve is in the second operational state.

In still another embodiment, when the diverter valve is in the first operational state, heat transfer does not take place in the refrigerant-to-refrigerant heat exchanger.

In yet another embodiment, the refrigerant-to-refrigerant heat exchanger is downstream of the pump and upstream of the diverter valve.

In a further embodiment, the condenser is downstream of the diverter valve.

In another embodiment, when the diverter valve is in the second operational state, two-phase refrigerant is compressed into a vapor state in the compressor, flows from the compressor to the refrigerant-to-refrigerant heat exchanger where heat transfer occurs, flows from the refrigerant-to-refrigerant heat exchanger to the expansion valve, flows from the expansion valve to the evaporator to cool the battery, and flows from the evaporator back to the compressor.

In still another embodiment, the vehicle further includes a controller for controlling the operational state of the diverter valve and for activating/deactivating the compressor.

In yet another embodiment, the vehicle further includes a sensor coupled to the controller, the sensor configured to sense ambient air temperatures.

In a further embodiment, when a temperature of the vehicle is at or below a first temperature, the compressor is deactivated and the diverter value is in the first operational state, and when the temperature of the vehicle is a second temperature greater than the first temperature, the controller activates the compressor and controls the diverter valve to switch to the second operational state.

In another embodiment, the vapor compression circuit further includes a vehicle air conditioning evaporator for providing cooling to a cab of the vehicle.

In still another embodiment, the vehicle further includes a fan that assists the vehicle air conditioning evaporator in the absorption of heat.

In yet another embodiment, the vapor compression circuit further includes a second expansion valve for controlling refrigerant flow rate to the vehicle air conditioning evaporator.

In a further embodiment, refrigerant is directed from the refrigerant-to-refrigerant heat exchanger to the expansion valve to control refrigerant flow rate to the battery evaporator and to the second expansion valve to control refrigerant flow rate to the vehicle air conditioning evaporator.

In another embodiment, refrigerant exiting the battery evaporator and the vehicle air conditioning evaporator flows to the compressor.

In still another embodiment, the pumped loop cooling circuit further includes an electric motor for driving the vehicle, the electric motor having at least one cooling line running therethrough for cooling the electric motor.

In yet another embodiment, the electric motor is downstream of the power electronics and upstream of the condenser.

In a further embodiment, a filter/dryer downstream of the pump for filtering out contaminants and absorbing moisture.

In another embodiment, the battery is a lithium-ion battery.

According to another aspect of the invention, a cooling system for a vehicle is provided that includes a pumped loop cooling circuit including a pump and a condenser, a vapor compression circuit including an expansion valve and a compressor, a refrigerant-to-refrigerant heat exchanger having first and second flow passages in heat exchange relationship, the first flow passage forming part of the pumped loop cooling circuit and the second flow passage forming part of the vapor compression circuit and serving as a condenser in the vapor compression circuit, a cold plate for effecting thermal communication with a battery to be cooled, the cold plate having a first flow passage forming part of the pumped loop cooling circuit and a second flow passage forming part of the vapor compression circuit, and a diverter valve for controlling the flow of a two-phase refrigerant through the pumped loop cooling circuit, the diverter valve having a first operational state for directing the refrigerant to the cold plate to cool the battery and a second operational state bypassing the cold plate.

In an embodiment, the pumped loop cooling circuit further including a second cold plate in heat exchange relationship with vehicle power electronics to cool the power electronics.

In another embodiment, the second cold plate is downstream of the diverter valve and upstream of the condenser.

In still another embodiment, when the diverter valve is in the first operational state, the two-phase refrigerant flows from the pump, through the refrigerant-to-refrigerant heat exchanger to the cold plate to cool the battery, from the cold plate to the second cold plate to cool the vehicle power electronics, and from the second cold plate to the condenser where the two-phase refrigerant is condensed and cooled via a fan blowing air across the condenser.

In yet another embodiment the pumped loop cooling circuit further includes a reservoir configured to receive the refrigerant from the condenser and deliver the refrigerant to the pump.

In a further embodiment, when the diverter valve is in the second operational state, the vapor compression circuit is activated to cool the battery with a two-phase refrigerant flowing through the vapor compression circuit.

In another embodiment, when a temperature of the vehicle is at or below a first temperature, the diverter valve is in the first operational state and when a temperature of the vehicle is a second temperature greater than the first temperature, the diverter valve is in the second operational state.

In still another embodiment, when the diverter valve is in the first operational state, heat transfer does not take place in the refrigerant-to-refrigerant heat exchanger.

In yet another embodiment, the refrigerant-to-refrigerant heat exchanger is downstream of the pump and upstream of the diverter valve.

In a further embodiment, the condenser is downstream of the diverter valve.

In another embodiment, when the diverter valve is in the second operational state, two-phase refrigerant is compressed into a vapor state in the compressor, flows from the compressor to the refrigerant-to-refrigerant heat exchanger where heat transfer occurs, flows from the refrigerant-to-refrigerant heat exchanger to the expansion valve, flows from the expansion valve to the cold plate to cool the battery, and flows from the cold plate back to the compressor.

In still another embodiment, the cooling system further includes a controller for controlling the operational state of the diverter valve and for activating/deactivating the compressor.

In yet another embodiment, the cooling system further includes a sensor coupled to the controller, the sensor configured to sense ambient air temperatures.

In a further embodiment, when a temperature of the vehicle is at or below a first temperature, the compressor is deactivated and the diverter value is in the first operational state, and when the temperature of the vehicle is a second temperature greater than the first temperature, the controller activates the compressor and controls the diverter valve to switch to the second operational state.

In another embodiment, the vapor compression circuit further includes a vehicle air conditioning evaporator for providing cooling to a cab of the vehicle.

In still another embodiment, the cooling system further includes a fan that assists the vehicle air conditioning evaporator in the absorption of heat.

In yet another embodiment, the vapor compression circuit further includes a second expansion valve for controlling refrigerant flow rate to the vehicle air conditioning evaporator.

In a further embodiment, refrigerant is directed from the refrigerant-to-refrigerant heat exchanger to the expansion valve to control refrigerant flow rate to the battery evaporator and to the second expansion valve to control refrigerant flow rate to the vehicle air conditioning evaporator.

In another embodiment, refrigerant exiting the battery cold plate and the vehicle air conditioning evaporator flows to the compressor.

In still another embodiment, the pumped loop cooling circuit further includes an electric motor for driving the vehicle, the electric motor having at least one cooling line running therethrough for cooling the electric motor.

In yet another embodiment, the electric motor is downstream of the power electronics and upstream of the condenser.

In a further embodiment, the cooling system further includes a filter/dryer downstream of the pump for filtering out contaminants and absorbing moisture.

In another embodiment, the cooling system is in combination with a vehicle having a battery, wherein the battery is a lithium-ion battery.

According to another aspect of the invention, a cooling system is providing including a refrigerant-to-refrigerant heat exchanger having first and second flow passages extending therethrough, a pump configured to direct fluid through the first flow passage of the heat exchanger, a compressor configured to direct fluid through the second flow passage of the heat exchanger, and a cold plate having first and second flow passages extending therethrough, the first flow passage of the cold plate configured to communicate with the first flow passage of the heat exchanger and the second flow passage of the cold plate configured to communicate with the second flow passage of the heat exchanger.

According to an embodiment, the cooling system further includes a diverter valve for controlling the flow of a two-phase refrigerant received from the first flow passage of the refrigerant-to-refrigerant heat exchanger, the diverter valve having a first operational state for directing the refrigerant to the cold plate to cool the battery and a second operational state bypassing the cold plate.

According to another embodiment, the cooling system further includes a condenser downstream of the diverter valve.

According to still another embodiment, the cooling system further includes an expansion valve for receiving refrigerant flowing through the second flow passage.

According to yet another embodiment, the cooling system further includes a second cold plate in heat exchange relationship with vehicle power electronics to cool the power electronics.

According to a further embodiment, the second cold plate is downstream of the diverter valve and upstream of the condenser.

According to still another embodiment, when the diverter valve is in the first operational state, the two-phase refrigerant flows from the pump, through the refrigerant-to-refrigerant heat exchanger to the cold plate to cool the battery, from the cold plate to the second cold plate to cool the vehicle power electronics, and from the second cold plate to the condenser where the two-phase refrigerant is condensed and cooled via a fan blowing air across the condenser.

According to yet another embodiment, the cooling system further includes a reservoir configured to receive the refrigerant from the condenser and deliver the refrigerant to the pump.

According to a further embodiment, when a temperature of the vehicle is at or below a first temperature, the diverter valve is in the first operational state and when a temperature of the vehicle is a second temperature greater than the first temperature, the diverter valve is in the second operational state.

According to another embodiment, when the diverter valve is in the first operational state, heat transfer does not take place in the refrigerant-to-refrigerant heat exchanger.

According to still another embodiment, the refrigerant-to-refrigerant heat exchanger is downstream of the pump and upstream of the diverter valve.

According to yet another embodiment, when the diverter valve is in the second operational state, two-phase refrigerant is compressed into a vapor state in the compressor, flows from the compressor to the refrigerant-to-refrigerant heat exchanger where heat transfer occurs, flows from the refrigerant-to-refrigerant heat exchanger to the expansion valve, flows from the expansion valve to the cold plate to cool the battery, and flows from the cold plate back to the compressor.

According to a further embodiment, the cooling system further includes a controller for controlling the operational state of the diverter valve and for activating/deactivating the compressor.

According to another embodiment, the cooling system further includes a sensor coupled to the controller, the sensor configured to sense ambient air temperatures.

According to still another embodiment, when a temperature of the vehicle is at or below a first temperature, the compressor is deactivated and the diverter value is in the first operational state, and when the temperature of the vehicle is a second temperature greater than the first temperature, the controller activates the compressor and controls the diverter valve to switch to the second operational state.

According to yet another embodiment, the cooling system further includes a filter/dryer downstream of the pump for filtering out contaminants and absorbing moisture.

According to a further embodiment, the cooling system is in combination with a vehicle having a battery, wherein the battery is a lithium-ion battery.

According to another aspect of the invention, a method of cooling a battery in a vehicle using a cooling system is provided. The method includes, when a temperature of the vehicle is below a first temperature, pumping two-phase refrigerant from a pump through a first flow passage of a refrigerant-to-refrigerant heat exchanger, directing two-phase refrigerant from the first flow passage through a diverter valve to a first flow passage of a battery cold plate where battery heat is pulled away from the battery, and directing two-phase refrigerant from the first flow passage of the battery cold plate to a condenser heat exchanger where the heat is rejected to ambient air.

According to an embodiment, the method includes, when a temperature of the vehicle is a second temperature above the first temperature, compressing a two-phase refrigerant into a vapor state in a compressor, directing the compressed two-phase refrigerant from the compressor to a second flow passage of the refrigerant-to-refrigerant heat exchanger, rejecting heat in the second flow passage to the two-phase refrigerant in the first flow passage, directing the two-phase refrigerant to an expansion valve, expanding the two-phase refrigerant in the expansion valve, and directing the two-phase refrigerant from the expansion valve through a second flow passage of the cold plate where battery heat is pulled away from the battery.

According to still another embodiment, the method includes, when the temperature of the vehicle is the second temperature, pumping the two-phase refrigerant from the pump through the first flow passage of the refrigerant-to-refrigerant heat exchanger where heat is absorbed from the second flow passage of the refrigerant-to-refrigerant heat exchanger, directing the two-phase refrigerant from the first flow passage of the refrigerant-to-refrigerant heat exchanger through the diverter valve, where the diverter valve has been switched to bypass the cold plate, and directing two-phase refrigerant from the diverter valve to the condenser heat exchanger where the heat is rejected to ambient air.

The foregoing and other features of the invention are hereinafter described in greater detail with reference to the accompanying drawings.

### BRIEF DESCRIPTION OF THE DRAWINGS

FIG. 1 is a schematic diagram of an exemplary cooling system according to the invention;

FIG. 2 is a schematic diagram of another exemplary cooling system according to the invention;

FIG. 3 is a schematic diagram of still another exemplary cooling system according to the invention;

### DETAILED DESCRIPTION

The principles of the present application have particular application to cooling systems for hybrid electric vehicles and thus will be described below chiefly in this context. It will of course be appreciated, and also understood, that the principles of the invention may be useful in other cooling systems where it is desirable to not have a dedicated vapor compression cooling system for cooling batteries.

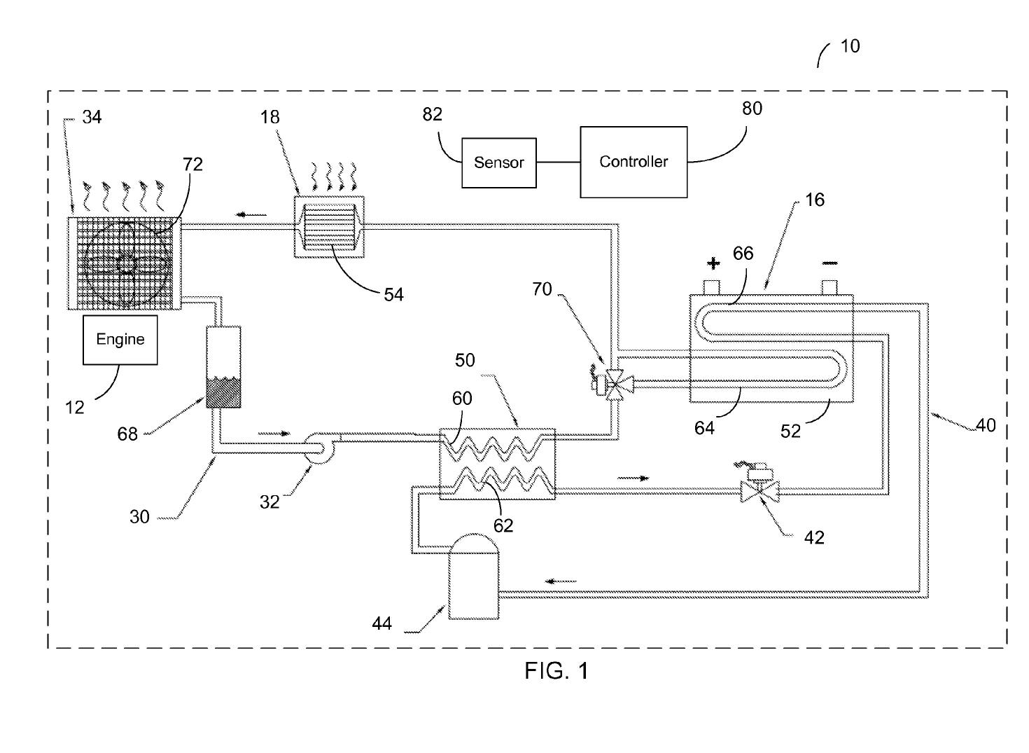

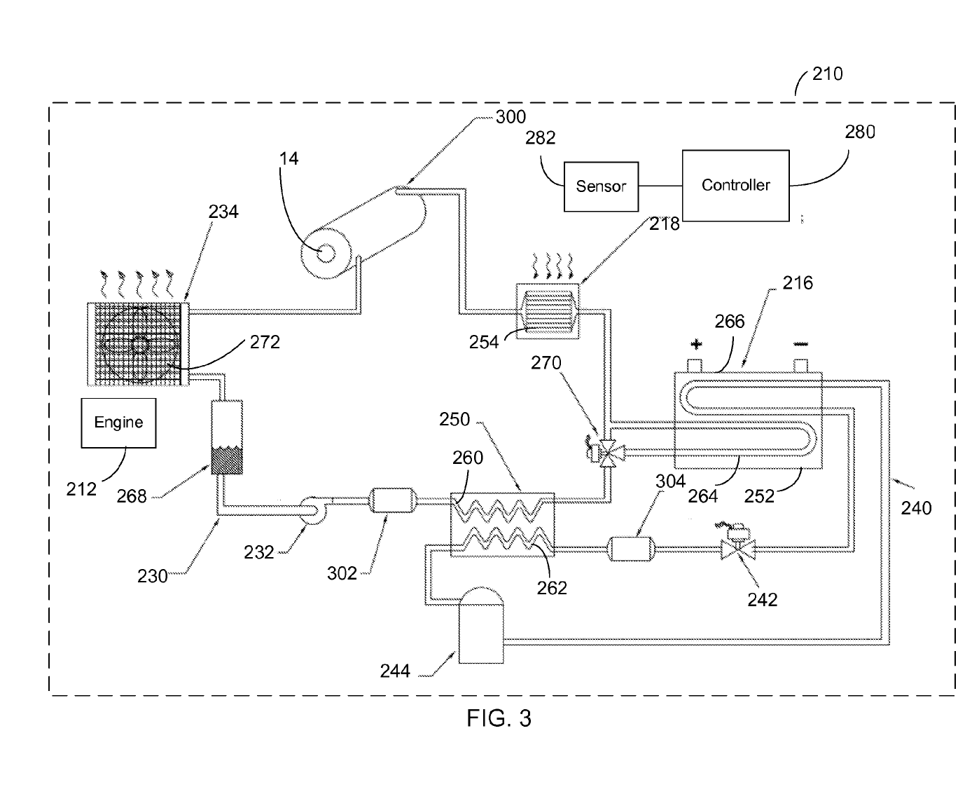

Referring now in detail to the drawings and initially to FIG. 1, a schematic representation of a vehicle is illustrated generally at 10. The vehicle includes an engine 12, one or more electric motors 14 (FIG. 3), one or more batteries 16 for energy storage and power electronics 18, such as IGBT modules, that convert the energy in the battery to energy for driving the electric motor. The engine, electric, motors, batteries and power electronics may be of conventional design, for example, the batteries may be any suitable batteries such as lithium-ion batteries.

The vehicle 10 also includes a pumped loop cooling circuit 30 including a pump 32 and a condenser heat exchanger 34, a vapor compression circuit 40 including an expansion valve 42 and a compressor 44, a refrigerant-to-refrigerant heat exchanger 50, and an evaporator 52, such as a direct contact evaporator, which may be, for example, a cold plate. The refrigerant-to-refrigerant heat exchanger 50 has first and second flow passages 60 and 62 in heat exchange relationship with one another. The first flow passage 60 forms part of the pumped loop cooling circuit 30 and the second flow passage 62 forms part of the vapor compression circuit 40 and serves as a condenser in the vapor compression circuit. The cold plate 52, which is in heat exchange relationship with the battery 16 to cool the battery, has a first flow passage 64 forming part of the pumped loop cooling circuit 30 and a second flow passage 66 forming part of the vapor compression circuit.

The pumped loop cooling circuit 30 may also include a reservoir tank 68, a diverter valve 70, such as a three-way diverter valve, and an evaporator 54, such as a direct contact evaporator, which may be, for example, a cold plate. The cold plate 54 is in heat exchange relationship with the power electronics 18 to cool the power electronics and has a flow passage therethrough that directs refrigerant to the condenser 34. The reservoir tank 68, which may be any suitable reservoir, is configured to receive the refrigerant from the condenser 34 and deliver the refrigerant to the pump 32. The diverter valve 70 controls the flow of a two-phase fluid, such as a two-phase refrigerant, through the pumped loop cooling circuit 30. The diverter valve has a first operational state for directing the refrigerant to the cold plate 52 to cool the battery 16 and a second operational state bypassing the cold plate 52.

During low ambient air temperatures, for example when the ambient air temperature is approximately 25° Celsius or less, the diverter valve is in the first operational state. When the diverter valve is in the first operational state, the pump 32 directs two-phase refrigerant through the first flow passage 60 of the refrigerant-to-refrigerant heat exchanger 50, where no heat transfer takes place. The two-phase refrigerant then flows through the diverter valve 70 through the first flow passage 64 of the cold plate 52. The battery heat is pulled away from the battery 16 by the two-phase refrigerant, which starts to boil when it absorbs the heat. The two-phase refrigerant then flows out of the first flow passage 64 to the cold plate 54 where heat is pulled away from the power electronics 18 by the two-phase refrigerant, further boiling the refrigerant. The two-phase refrigerant then flows to the condenser 34, which rejects the heat to the ambient air via a fan 72 blowing air across the condenser and condenses the two-phase refrigerant to a liquid state. The two-phase refrigerant then flows into the reservoir tank 68, which compensates for varying volumes in the pumped loop cooling circuit. From the reservoir tank the two-phase refrigerant, in liquid form, returns to the pump 32.

During the low ambient air temperatures, the vapor compression loop 40 does not operate. In this way, the battery 16 is cooled without operating the compressor 44, thereby reducing energy usage. Additionally, as noted above, during low ambient air temperatures heat transfer does not take place in the refrigerant-to-refrigerant heat exchanger 50 and therefore the two-phase refrigerant is not heated as it flows through the heat exchanger 50.

During high ambient air temperatures, for example when the ambient air temperature is above 25° Celsius, the diverter valve 70 is in the second operational state and the vapor compression circuit 40 is activated to cool the battery 16 with a two-phase fluid, such as a two-phase refrigerant flowing through the vapor compression circuit. When the diverter valve is in the second operational state, the two-phase refrigerant in the vapor compression circuit is compressed into a vapor state in the compressor 44. The vapor then flows to the second flow passage 62 of the refrigerant-to-refrigerant heat exchanger 50, where heat is rejected to the two-phase refrigerant flowing through the first flow passage 60 of the heat exchanger 50. The refrigerant-to-refrigerant heat exchanger 50 acts as a condenser and condenses the two-phase refrigerant to a liquid state, which then flows to the expansion valve 42 where the fluid is expanded to a low pressure liquid-vapor. The liquid-vapor then flows from the expansion valve through the second flow passage 66 of the cold plate 52 where the battery heat is pulled away from the battery 16 by the two-phase refrigerant. The two-phase refrigerant then flows from the cold plate 52 back to the compressor 44.

During operation of the vapor compression circuit 40, the diverter valve switches so that the two-phase refrigerant bypasses the cold plate 52. Under these temperature conditions, the refrigerant is diverted away from the battery because the temperature of the refrigerant will be hotter than a maximum operation temperature of the battery. In the pumped loop cooling circuit, the pump 32 directs the two-phase refrigerant through the first passage 60 of refrigerant-to-refrigerant heat exchanger 50 where heat is absorbed from the second flow path 62, and the two-phase refrigerant boils. The two-phase refrigerant then flows through the diverter valve 70 to the cold plate 54 where heat is pulled away from the power electronics 18 by the two-phase refrigerant, which further boils. The two-phase refrigerant then flows to the condenser 34, which rejects the heat to the ambient air via the fan 72 and condenses the two-phase refrigerant to a liquid state. The two-phase refrigerant then flows into the reservoir tank 68 and back to the pump 32.

As noted above, during low ambient air temperatures, the battery 16 and power electronics 18 are cooled to their respective operational temperatures by the pumped loop cooling circuit 30, which provides an efficient system due to low power consumption of the pump. During high ambient air temperatures, the vapor compression circuit 40 is activated to cool the battery 16 to its operational temperature. The foregoing cooling system includes one heat exchanger, the condenser heat exchanger 34, to ambient air, which reduces weight and cost of the vehicle and also provides a more compact package design. The cooling system also does not require a separate vapor compression circuit to cool each of the batteries and the power electronics, thereby avoiding using multiple compressors and avoiding the need to run a compressor when the ambient air temperature is below 25° Celsius.

To control the operational state of the diverter valve 70 and to activate/deactivate the compressor 44, the vehicle 10 may include a controller 80. The vehicle may also include one or more sensors 82 coupled to the controller, the one or more sensors configured to sense the ambient air temperatures in the vehicle. When the one or more sensors 82 senses that the ambient air temperature in the vehicle is at or below a first temperature, the controller 80 deactivates the compressor 44 or takes no action regarding the compressor. The controller also controls the diverter valve 70 to switch to the first operational state. When the one or more sensors 82 senses that the ambient air temperature in the vehicle is a second temperature greater than the first temperature, the controller 80 activates the compressor 44 and controls the diverter valve 70 to switch to the second operational state. The controller is also configured to sense battery temperature and/or the temperature of the two-phase refrigerant in the pumped loop cooling circuit 30 to determine when to switch the diverter valve 70 and activate the compressor 44.

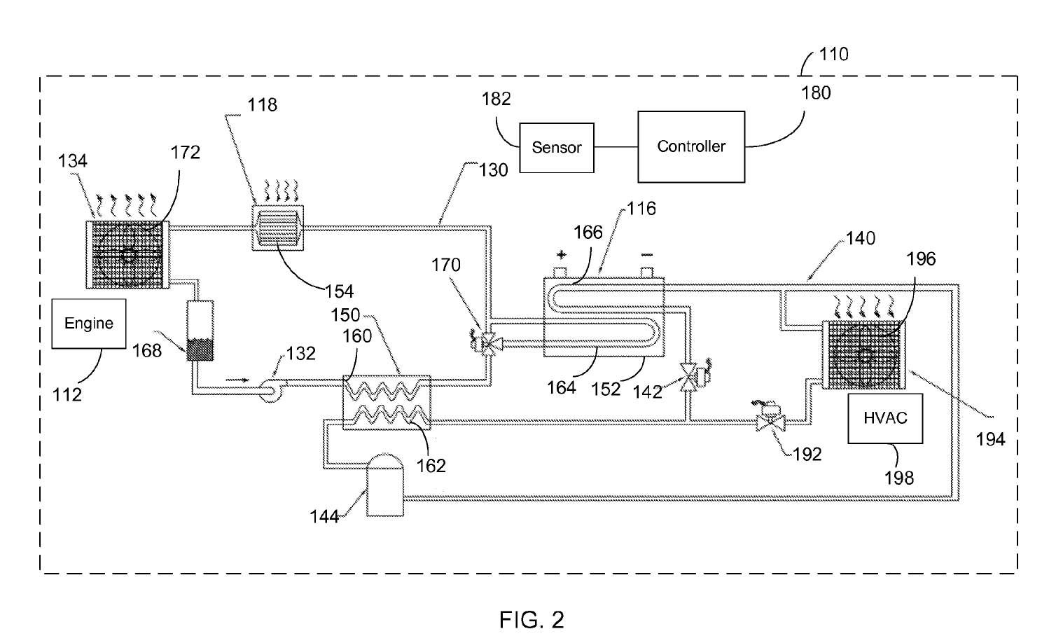

Turning now to FIG. 2, another exemplary embodiment of the vehicle is shown at 110. The vehicle 110 is substantially the same as the above-referenced vehicle 10, and consequently the same reference numerals but indexed by 100 are used to denote structures corresponding to similar structures in the vehicle. In addition, the foregoing description of the vehicle 10 is equally applicable to the vehicle 110 except as noted below.

The vehicle 110 includes a vapor compression circuit 140 including a first expansion valve 142, a compressor 144, a second expansion valve 192 and a vehicle air conditioning evaporator 194, thereby combining the vapor compression circuit shown in FIG. 1 with the vehicle HVAC cab cooling. The vehicle also includes a fan 196 that assists the vehicle air conditioning evaporator 194 in the absorption of heat.

During high ambient air temperatures, for example when the ambient air temperature is above 25° Celsius, the diverter valve 170 is in the second operational state and the vapor compression circuit 140 is activated to cool the battery 116 and the vehicle HVAC system 198 with the two-phase refrigerant flowing through the vapor compression circuit. When the diverter valve is in the second operational state, the two-phase refrigerant in the vapor compression circuit is compressed into a vapor state in the compressor 144. The vapor then flows to the second flow passage 162 of the refrigerant-to-refrigerant heat exchanger 150, where heat is rejected to the two-phase refrigerant flowing through the first flow passage 160 of the heat exchanger 150. The refrigerant-to-refrigerant heat exchanger 150 acts as a condenser and condenses the two-phase refrigerant to a liquid state, which then flows to the expansion valve 142 to control refrigerant flow rate to the cold plate 152 and to the second expansion valve 192 to control refrigerant flow rate to the vehicle air conditioning evaporator 194. The fluid expands in the expansion valves 142 and 192 to a low pressure liquid-vapor that flows through the second flow passage 166 of the cold plate 152 where the battery heat is pulled away from the battery 116 by the two-phase refrigerant and through the vehicle air conditioning evaporator 194 where the HVAC system heat is pulled away from the HVAC system 198 with the assistance of the fan 196. The two-phase refrigerant then flows from the cold plate 152 and the evaporator 194 back to the compressor 144.

By including HVAC system in the vapor compression circuit 140, a single compressor may be used to cool the batteries 116 and the vehicle air conditioning evaporator 194. In some instances, it may be desirable to cool the battery 116 using the vapor compression circuit 140 but not the HVAC system 198. In these instances, a diverter value may be provided to bypass the second expansion valve 192.

Turning now to FIG. 3, another exemplary embodiment of the vehicle is shown at 210. The vehicle 210 is substantially the same as the above-referenced vehicles 10, and consequently the same reference numerals but indexed by 200 are used to denote structures corresponding to similar structures in the vehicle. In addition, the foregoing description of the vehicle 10 and 110 is equally applicable to the vehicle 210 except as noted below.

The vehicle 210 includes a pumped loop cooling circuit including a pump 232, a refrigerant-to-refrigerant heat exchanger 250, a diverter valve 270, a cold plate 254, an electric motor housing 300 downstream of the cold plate 254 for housing the electric motor 14, and a condenser heat exchanger 234. The electric motor housing, or alternatively the electric motor, includes at least one cooling line running therethrough for cooling the motor. The pumped loop cooling circuit may also include a reservoir tank 268 and a filter/dryer 302 downstream of the pump 232 for filtering out contaminants and absorbing moisture. The vapor compression circuit 240 may also include a filter/dryer 304 downstream of the refrigerant-to-refrigerant heat exchanger 250 for filtering out contaminants and absorbing moisture.

During low ambient air temperatures, for example when the ambient air temperature is approximately 25° Celsius or less, the diverter valve 270 is in the first operational state. When the diverter valve is in the first operational state, the pump 232 directs two-phase refrigerant through the filter/dryer 302 to the first flow passage 260 of the refrigerant-to-refrigerant heat exchanger 250, where no heat transfer takes place. The two-phase refrigerant then flows through the diverter valve 270 through the first flow passage 264 of the cold plate 252, where the battery heat is pulled away from the battery 216. The two-phase refrigerant then flows out of the first flow passage 264 to the cold plate 254 where heat is pulled away from the power electronics 218. The two-phase refrigerant then flows through the cooling lines in the electric motor housing 300 to cool the electric motor. The two-phase refrigerant then flows to the condenser 234, which rejects the heat to the ambient air. The two-phase refrigerant then flows into the reservoir tank 268 and then returns to the pump 232.

When the diverter valve is in the second state, similar to when in the first state, after the two-phase refrigerant bypasses the cold plate 52, the two-phase refrigerant flows to the cold plate 254 where heat is pulled away from the power electronics 218. The two-phase refrigerant then flows through the cooling lines in the electric motor housing 300 to cool the electric motor 14. The two-phase refrigerant then flows to the condenser 234, which rejects the heat to the ambient air.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1-23. (canceled)

24. A cooling system for a vehicle including:
a pumped loop cooling circuit including a pump and a condenser;
a vapor compression circuit including an expansion valve and a compressor;
a refrigerant-to-refrigerant heat exchanger having first and second flow passages in heat exchange relationship, the first flow passage forming part of the pumped loop cooling circuit and the second flow passage forming part of the vapor compression circuit and serving as a condenser in the vapor compression circuit;
a cold plate for effecting thermal communication with a battery to be cooled, the cold plate having a first flow passage forming part of the pumped loop cooling circuit and a second flow passage forming part of the vapor compression circuit; and
a diverter valve for controlling the flow of a two-phase refrigerant through the pumped loop cooling circuit, the diverter valve having a first operational state for directing the refrigerant to the cold plate to cool the battery and a second operational state bypassing the cold plate.

25. A cooling system for a vehicle according to claim 24, the pumped loop cooling circuit further including a second cold plate in heat exchange relationship with vehicle power electronics to cool the power electronics.

26. A cooling system for a vehicle according to claim 25, wherein the second cold plate is downstream of the diverter valve and upstream of the condenser.

27. A cooling system for a vehicle according to claim 25, wherein when the diverter valve is in the first operational state, the two-phase refrigerant flows from the pump, through the refrigerant-to-refrigerant heat exchanger to the cold plate to cool the battery, from the cold plate to the second cold plate to cool the vehicle power electronics, and from the second cold plate to the condenser where the two-phase refrigerant is condensed and cooled via a fan blowing air across the condenser.

28. A cooling system for a vehicle according to claim 24, wherein the pumped loop cooling circuit further includes a reservoir configured to receive the refrigerant from the condenser and deliver the refrigerant to the pump.

29. A cooling system for a vehicle according to claim 24, wherein when the diverter valve is in the second operational state, the vapor compression circuit is activated to cool the battery with a two-phase refrigerant flowing through the vapor compression circuit.

30. A cooling system for a vehicle according to claim 24, wherein when a temperature of the vehicle is at or below a first temperature, the diverter valve is in the first operational state and when a temperature of the vehicle is a second temperature greater than the first temperature, the diverter valve is in the second operational state.

31. A cooling system for a vehicle according to claim 24, wherein when the diverter valve is in the first operational state, heat transfer does not take place in the refrigerant-to-refrigerant heat exchanger.

32. A cooling system for a vehicle according to claim 24, wherein the refrigerant-to-refrigerant heat exchanger is downstream of the pump and upstream of the diverter valve.

33. A cooling system for a vehicle according to claim 24, wherein the condenser is downstream of the diverter valve.

34. A cooling system for a vehicle according to claim 24, wherein when the diverter valve is in the second operational state, two-phase refrigerant is compressed into a vapor state in the compressor, flows from the compressor to the refrigerant-to-refrigerant heat exchanger where heat transfer occurs, flows from the refrigerant-to-refrigerant heat exchanger to the expansion valve, flows from the expansion valve to the cold plate to cool the battery, and flows from the cold plate back to the compressor.

35. A cooling system for a vehicle according to claim 24, further including a controller for controlling the operational state of the diverter valve and for activating/deactivating the compressor.

36. A cooling system for a vehicle according to claim 35, further including a sensor coupled to the controller, the sensor configured to sense ambient air temperatures.

37. A cooling system for a vehicle according to claim 36, wherein when a temperature of the vehicle is at or below a first temperature, the compressor is deactivated and the diverter value is in the first operational state, and when the temperature of the vehicle is a second temperature greater than the first temperature, the controller activates the compressor and controls the diverter valve to switch to the second operational state.

38. A cooling system for a vehicle according to claim 24, wherein the vapor compression circuit further includes a vehicle air conditioning evaporator for providing cooling to a cab of the vehicle.

39. A cooling system for a vehicle according to claim 38, further including a fan that assists the vehicle air conditioning evaporator in the absorption of heat.

40. A cooling system for a vehicle according to claim 38, wherein the vapor compression circuit further includes a second expansion valve for controlling refrigerant flow rate to the vehicle air conditioning evaporator.

41-46. (canceled)

47. A cooling system for a vehicle including:
a refrigerant-to-refrigerant heat exchanger having first and second flow passages extending therethrough;
a pump configured to direct fluid through the first flow passage of the heat exchanger;
a compressor configured to direct fluid through the second flow passage of the heat exchanger; and
a cold plate having first and second flow passages extending therethrough, the first flow passage of the cold plate configured to communicate with the first flow passage of the heat exchanger and the second flow passage of the cold plate configured to communicate with the second flow passage of the heat exchanger.

48. A cooling system for a vehicle according to claim 47, further includes a diverter valve for controlling the flow of a two-phase refrigerant received from the first flow passage of the refrigerant-to-refrigerant heat exchanger, the diverter valve having a first operational state for directing the refrigerant to the cold plate to cool the battery and a second operational state bypassing the cold plate.

49-63. (canceled)

64. A method of cooling a battery in a vehicle using a cooling system, the method including:
when a temperature of the vehicle is below a first temperature:
pumping two-phase refrigerant from a pump through a first flow passage of a refrigerant-to-refrigerant heat exchanger;
directing two-phase refrigerant from the first flow passage through a diverter valve to a first flow passage of a battery cold plate where battery heat is pulled away from the battery; and
directing two-phase refrigerant from the first flow passage of the battery cold plate to a condenser heat exchanger where the heat is rejected to ambient air.

65. (canceled)

66. (canceled)
